(19) United States
(12) Patent Application Publication
(10) Pub. No.: US 2008/0037128 A1
(43) Pub. Date: Feb. 14, 2008

(54) Coatings for replicating the spectral performance of colored glass

(75) Inventor: Jamie Knapp, Mendon, MA (US)

Correspondence Address: Brian F. Swienton;Newport Corporation, 1791 Deere Avenue, Irvine, CA, 92606, US

(73) Assignee: Newport Corporation, Irvine, CA (US)

(21) Appl. No.: 11/891,994

(22) Filed: Aug. 13, 2007

Related U.S. Application Data
(60) Provisional application No. 60/837,055, filed on Aug. 11, 2006.

(51) Int. Cl. G02B 1/10; H05H 1/24

(52) U.S. Cl. 359/586; 359/885; 427/569

(57) ABSTRACT

Optical filters are provided that include a coating layer formed of multiple thin film materials deposited on a visually transparent substrate, wherein the optical filters meet or exceed the physical properties and/or the spectral performance properties of comparable long-pass colored glasses regardless of the transmittance transition point of the colored glasses.

### CROSS REFERENCE TO RELATED APPLICATIONS

The present application claims priority to U.S. Provisional Patent Application Ser. No. 60837,055, filed Aug. 11, 2006, the contents of which are hereby incorporated by reference in its entirety herein.

### BACKGROUND

At present, colored glasses are utilized for a wide range of applications in various industries (e.g., photography, astronomy, specialty lighting, biomedicine and measurement), due at least in part to their inexpensiveness and ease of manufacture. One of the most useful features of colored glasses is their ability to function as so-called “long pass” devices, wherein their spectral performance is highly tuned such that the glasses optically reject all wavelengths of light falling within the entire x-ray portion and some of the ultraviolet portion of the electromagnetic spectrum (i.e., 200 nm and below) plus at least some additional wavelengths of light falling within the ultraviolet and visible portions of the electromagnetic spectrum (i.e., between 200 nm and 850 nm) while also passing though (i.e., transmitting) all wavelengths falling within the infrared portion of the electromagnetic spectrum (i.e., above 1000 nm). This is illustrated generally in the graph of FIG. 1, which also depicts another useful feature of “long pass” colored glasses, namely their “edge steepness,” which refers to their beneficially abrupt (i.e., occurring over a short total wavelength span) change from their minimum transmittance (i.e., nearly complete optical rejection occurring at about 0.001% transmittance) to their maximum transmittance (i.e., nearly complete optical transmittance occurring at about 90% transmittance).

There are several current manufacturers of “long pass” colored glass, including, for example, Schott North America, Inc. (“Schott”) of Elmsford, N.Y. USA, Hoya Corporation of Tokyo, Japan, and Isuzu Glass of Osaka, Japan. Each manufacturer sells various colored glasses, which are classified with a prefix that describes their color and a suffix that corresponds to the approximate “transmittance transition point” of the colored glass, namely the wavelength at which the colored glass becomes transmissive (i.e., the point on a spectral performance graph corresponding to approximately 50% transmittance).

For example, Schott currently sells colored glasses under product names such as WG-225, WG-280, WG-295, WG-305, WG-335, WG-345, WG-360, GG-375, GG-400, GG-420, GG-435, GG-455, GG-475, GG-495, OG-515, OG-530, OG-550, OG-570, OG-590, RG-610, RG-630, RG-645, RG-665, RG-695, RG-715, RG-780, RG-830 and RG-1000, wherein the “WG” glasses are visually clear, x-ray blocking, ultraviolet transmitting glasses, the “GG” glasses are yellow in color, the “OG” glasses and “RG” glasses having a transmittance transition point less than or equal to 665 nm are red/orange in color, and the “RG” glasses having a transmittance transition point of 695 nm or above are infrared transmitting glasses that have a black color.

FIG. 2 depicts a version of generalized FIG. 1 that has been modified to reflect the spectral performance/behavior of WG-320, which is a type of colored glass formerly made by Schott. As shown in FIG. 2, the WG-320 colored glass exhibited its minimum transmittance (i.e., about 0.001% transmittance) at and below about 310 nm and its maximum transmittance (i.e., about 90% transmittance) at and above about 370 nm. As noted above, the WG-320 product was referred to by that name because 320 nm represented the transmittance transition point for the colored glass. Other Schott colored glasses are similarly named—that is, the GG-435 product has a transmittance transition point at approximately 435 nm, the OG-550 product has a transmittance transition point at approximately 550 nm, the RG-790 product has a transmittance transition point at approximately 790 nm, etc.

From reviewing the exemplary spectral performance graphs of FIGS. 1 and 2, it is clear that the abrupt change from minimum to maximum transmittance occurs within a very narrow wavelength span, which, in the case of WG-320, is about 60 nm. The change from minimum transmittance to the transmittance transition point is even more abrupt, occurring within only about 10 nm. These abrupt changes create “edge steepness,” which is observed with regard to all “long pass” colored glasses and provides important benefits in the industries listed above because it enables one to select a colored glass that nearly completely optically rejects shorter wavelengths and nearly completely transmits certain higher wavelengths. For example, certain medical personnel utilize equipment that emits ultraviolet light having a wavelength that kills bacteria but that also can be damaging to one's eyes. Thus, the personnel can use protective eyewear incorporating colored glass that reliably blocks the damaging ultraviolet light but that also transmits light having harmless higher wavelengths.

However, despite these and other important benefits of colored glasses, they also possess several significant drawbacks. Most notably, many of such colored glasses are manufactured from one or more materials (e.g., compounds containing lead and/or cadmium) deemed to be hazardous according to the EC-RoHS Directive regarding hazardous substances in glass. In apparent response to this Directive, current colored glass manufacturers already have begun to wind down their production of colored glasses containing such materials, and, in certain instances (e.g., WG-320 as noted above), have discontinued production of such glasses altogether. This is highly problematic for those who have come to rely and depend upon the colored glasses that already have been or soon may be discontinued.

Another drawback of colored glasses is related to their as-manufactured dimensions. Colored glasses must be quite thick (i.e., at least 3 mm thick) in order to provide the optical rejection required for certain applications, but they also tend to be limited in their as-manufactured length and width. This is not ideal for those who wish to use colored glasses that are thinner, longer and/or wider than these limitations.

Yet another drawback of colored glasses is that they tend to be markedly temperature sensitive, wherein their spectral performance can shift at rates of 0.06 nm/° C. or above. Moreover, unless they have undergone costly tempering, colored glasses can be damaged when exposed to temperatures commonly encountered in various industries in which colored glasses are or could be useful. This disadvantageously requires those who use colored glasses either to monitor the temperatures that are present within their colored glass usage environments or to use other, perhaps suboptimally performing materials in lieu of the colored glasses.

Colored glasses also are sensitive to atmospheres in which certain materials and/or conditions are present. For example, colored glasses have been observed to physically and/or optically degrade when placed within environments in which moisture, acids and/or alkalines are present. Again, this forces those who use colored glasses either to be wary of what is present within their colored glass usage environments, or to use other, perhaps suboptimally performing materials in lieu of the colored glasses.

Still another drawback of colored glasses is that many of them are manufactured using materials that are prone to undergo autofluorescence, thus rendering the colored glasses unsuitable for certain applications. For example, it is common to use fluorescence to detect emissions indicative of the presence of hormones, DNA or the like within blood samples. However, if colored glasses form the optics used in such procedures, then one cannot be sure whether detected fluorescence is due to the presence of sample emissions, or, instead, from the autofluorescence of the colored glass(es) itself/themselves. This can lead to serious errors and/or misdiagnosis.

Still yet another drawback of colored glasses is that they are only manufactured in discrete wavelengths. For example, as noted above Schott sells GG-375 and GG-400 colored glasses, which have transmittance transition point of 375 nm and 400 nm respectively. However, there is no in between—that is, Schott does not sell a colored glass with a transmittance transition point between 375 nm and 400 nm.

In view of these drawbacks, some in the art have begun to experiment with creating substitute “long pass” devices. One example is a laminated dye plate 10, which, as shown schematically in FIG. 3, is formed of two sheets 20, 30 of transparent glass laminated together so as to surround a polymer-based (e.g., epoxy) dye 40. Unfortunately, these substitute devices suffer from some of the same drawbacks as colored glasses (e.g., they are made from materials deemed hazardous, they have minimum as-manufactured thicknesses above 3 mm, they can be damaged by high temperatures, they are prone to autofluorescence) plus still other drawbacks (e.g., they tend to undergo photo-bleaching when exposed to intense light and/or there can be inconsistencies in the thickness of the epoxy dye layer 30, either or both of which can negatively affect spectral performance).

Moreover, these substitute “long pass” devices tend not to closely mimic or replicate the highly tuned spectral performance of colored glasses. For example, FIG. 4 depicts the spectral performance of a laminated dye plate that was intended to replicate the spectral performance of a GG-400 “long pass” colored glass—that is, a colored glass having a transmittance transition point at approximately 400 nm as shown in the FIG. 10 graph. It is evident from comparing the FIG. 4 and FIG. 10 graphs, however, that the spectral performance of the laminated dye plate 10 of FIG. 3 does not closely resemble that of a comparable colored glass. For one, the transmittance transition point of the dye plate is not 400 nm, but instead occurs at about 430 nm. Also, the maximum transmittance of the dye plate is only about 88% whereas the maximum transmittance of the colored glass goes above 90%. Moreover, the change from minimum transmittance to maximum transmittance for the GG-400 replicating laminated dye plate is far less abrupt (i.e., less edge steep) than for the GG-400 colored glass, especially within the range of about 70% transmittance to the level of maximum transmittance. That, in turn, also causes the change from nearly complete optical rejection to maximum transmittance for the laminated dye plate to occur over a somewhat longer overall wavelength. Also, the change from minimum transmittance to the transmittance transition point for the GG-400 replicating laminated dye plate is similarly non-abrupt and less edge steep (i.e., it occurs over a comparatively longer overall wavelength span) as compared to that of the GG-400 colored glass. Such non-abrupt changes would be unacceptable for at least some, if not most or all of the current applications of colored glasses.

Therefore, a need exists for devices and methods to that enable one to replicate the highly tuned spectral performance of colored glasses without being hindered by the various drawbacks attributable to usage and/or manufacture thereof.

### SUMMARY

The optical filters described in the present application meet these and other needs by providing optical filters that comprise a substrate and a coating deposited, applied or otherwise placed onto the substrate, wherein the coating is formed of a one or more layers of thin film materials. The spectral performance of such optical filters meets or exceeds that of a comparable colored glass.

In one embodiment, the optical filter has a minimum spectral transmittance level and a maximum spectral transmittance level, wherein the transition from the minimum spectral transmittance level to the maximum spectral transmittance level occurs within a wavelength span of less than about 100 nm. In another embodiment, the optical filter has a minimum spectral transmittance level, a maximum spectral transmittance level, and a transmittance transition point therebetween, wherein the transition from the minimum spectral transmittance level to the maximum spectral transmittance level occurs within a wavelength span of less than 100 nm, and wherein the transition from each of the minimum spectral transmittance level to the transmittance transition point and from the transmittance transition point to the maximum spectral transmittance level occurs within a wavelength span of at most 50 nm.

In yet another embodiment, the optical filter has a minimum spectral transmittance level and a maximum spectral transmittance level, wherein the transition between the minimum spectral transmittance level and the maximum spectral transmittance level commences at a maximum wavelength measurement of the minimum spectral transmittance level and concludes at a minimum wavelength measurement of the maximum spectral transmittance level, and wherein the maximum wavelength measurement is equal to at least 80% of the minimum wavelength measurement.

In a further embodiment, the optical filter has a minimum spectral transmittance level and a transmittance transition point, wherein the transmittance transition point occurs at a predetermined wavelength, and wherein the transition from the minimum spectral transmittance level to the transmittance transition point commences at a maximum wavelength measurement of the minimum spectral transmittance level, and wherein the maximum wavelength measurement of the minimum spectral transmittance level is equal to at least 80% of predetermined wavelength of the transmittance transition point.

In a still further embodiment, the optical filter has a maximum spectral transmittance level and a transmittance transition point, and wherein the transmittance transition point occurs at a predetermined wavelength, and wherein the transition from the transmittance transition point to the maximum spectral transmittance level commences at the transmittance transition point and concludes at a minimum wavelength measurement of the maximum spectral transmittance level, and wherein the predetermined wavelength of the transmittance transition point is equal to at least 80% of the minimum wavelength measurement of the maximum spectral transmittance level.

In a yet still further embodiment, the optical filter has a minimum spectral transmittance level and a maximum spectral transmittance level, and wherein the transition between the minimum spectral transmittance level and the maximum spectral transmittance level commences at a maximum wavelength measurement of the minimum spectral transmittance level and concludes at a minimum wavelength measurement of the maximum spectral transmittance level, and wherein the difference between the minimum wavelength measurement and the maximum wavelength measurement is equal to a wavelength that is less than at least one fourth of the maximum wavelength measurement.

Still other aspects, embodiments and advantages of the coatings and methods of manufacture are discussed in detail below. Moreover, it is to be understood that both the foregoing general description and the following detailed description are merely illustrative examples of various optical coatings, and are intended to provide an overview or framework for understanding the nature and character of the invention as it is claimed. The accompanying drawings are included to provide a further understanding of the various embodiments of the coatings and methods of manufacture described herein, and are incorporated in and constitute a part of this specification.

### BRIEF DESCRIPTION OF THE DRAWINGS

For a fuller understanding of the nature and desired objects of the various embodiments of the coatings and methods of manufacture as described herein, reference is made to the following detailed description, which is to be taken in conjunction with the accompanying drawing figures wherein any like reference characters denote corresponding parts throughout the several views presented within the drawing figures, and wherein:

FIG. 1 is a graph of wavelength versus percent transmittance depicting the generalized spectral performance of a “long pass” colored glass;

FIG. 2 is a graph of wavelength versus percent transmittance depicting the spectral performance for a WG-320 colored glass formerly manufactured by Schott;

FIG. 3 is a schematic front view of an exemplary laminated dye plate;

FIG. 4 is a graph of wavelength versus percent transmittance depicting the spectral performance for a FIG. 3 laminated dye plate that is intended to replicate the spectral performance of a GG-400 colored glass;

FIG. 5 is a schematic side view of an optical filter in accordance with the present application;

FIG. 6 is a graph of wavelength versus percent transmittance depicting the spectral performance of a first exemplary embodiment of the FIG. 5 optical filter;

FIG. 7 is a graph of wavelength versus percent transmittance depicting the spectral performance of a second exemplary embodiment of the FIG. 5 optical filter;

FIG. 8 is a graph of wavelength versus percent transmittance depicting the spectral performance of a third exemplary embodiment of the FIG. 5 optical filter;

FIG. 9 is a graph of wavelength versus percent transmittance depicting the spectral performance of a fourth exemplary embodiment of the FIG. 5 optical filter;

FIG. 10 is a graph of wavelength versus percent transmittance depicting the spectral performance for a GG-400 colored glass manufactured by Schott;

FIG. 11 is a graph of wavelength versus percent transmittance depicting the spectral performance for a OG-530 colored glass manufactured by Schott; and

FIG. 12 is a graph of wavelength versus percent transmittance depicting the spectral performance for a RG-715 colored glass manufactured by Schott.

### DETAILED DESCRIPTION

The present application discloses optical filters and methods of making optical filters, wherein such optical filters replicate the beneficial aspects of the spectral performance of so-called “long-pass” colored glass optical devices without encountering any of the various drawbacks associated with the use and/or manufacture of such colored glasses or of other devices (e.g., laminated dye plates). In particular, and as discussed further below, the optical filters of the present application can be manufactured so as to exhibit similar, if not improved, spectral performance as “long-pass” colored glass regardless of the transmittance transition point of the colored glass.

An exemplary optical filter 100 is shown schematically in FIG. 5. The optical filter 100 includes a coating 110 that has been applied, deposited or otherwise placed onto either side of a substrate 120 or other application area or target. If instead desired, a coating 110 can be applied/deposited/placed to both sides of the substrate 120, since doing so can enhance the performance of the filter, and/or can enable one to use the optical filter 100 even in the rare instance that a defect is found on the coating 110 of one side.

The coating 110 can be applied, deposited or placed onto the substrate 120 via one or more of various techniques; however, in one embodiment, the specific technique is selected so as to result in a coating that is permanent, resistant to/against the effects of the environment, and that does not spectrally shift upon exposure to varying temperature and/or humidity conditions. Exemplary suitable such application techniques for the coating 110 include, but are not limited to, reactive plasma-based deposition processes such as reactive ion plating, magnetron sputtering and ion-assisted electron beam evaporation as described, e.g., in U.S. Pat. Nos. 4,333,962, 4,448,802, 4,619,748, 5,211,759 and 5,229,570, each of which is incorporated by reference in its entirety herein.

In one embodiment, the coating 110 is comprised of multiple layers of thin film materials (e.g., materials having a thickness in the range of about 5 nm to about 1000 nm) deposited onto one side of the substrate 120 via a suitable technique (e.g., plasma-enhanced sputtering). Examples of suitable such thin film materials from which the coating can be entirely or partially formed include but are not limited to one or more oxide materials (e.g., metal oxides such as silicon dioxide (SiO₂), niobium oxide (Nb₂O₅), titanium oxide (TiO₂), hafnium oxide (HfO₂) and tantalum oxide (Ta₂O₅)), one or more sulfide materials and one or more fluoride materials, wherein such materials are currently preferable because they are pure, and thus will not be optically absorptive. Optionally, the coating 110 may be formed form a single layer of thin film material having a thickness in the range of about 5 nm to about 1000 nm, including any and all subranges therebetween.

In one embodiment, the coating 110 is comprised of multiple, alternating layers of two metal-oxides or alternating layers of at least one sulfide material and at least one fluoride material. By forming the coating as such, the alternating layers can have a high refractive index contrast, which, in turn, enables the coating to be formed of comparatively fewer total layers. Moreover, the alternating layers can be selected so as to enable the resulting filter 100 to have any transmittance transition point, including ones identical to those of colored glasses plus still other transmittance transition points not available in colored glasses. In an alternate embodiment, the coating 110 is comprised of at least some non-alternating oxide layers.

In one embodiment, coating 110 is applied/deposited/placed onto a substrate 120 that is formed of a transparent, non-optically interfering material. Examples of suitable such substrate materials may include borosilicate glasses, soda lime glasses, In an alternate embodiment, the substrate 120 comprises a silica-based substrate, various glasses, ceramics, composite materials, deformable optical elements such a deformable lenses or mirrors, Mylar, Kapton, polymers, polyimide films, polyester films, and the like. In an embodiment in which the coating 110 is formed of alternating layers of a sulfide material and a fluoride material, an additional substrate (not shown) can be joined (e.g., via epoxy) to the top layer of the coating. This occurs to compensate for the softness of the sulfide and fluoride materials.

By forming the optical filter 100 of a coating 110 of thin films atop a transparent non-optically absorptive substrate 120, the resultant optical filter possesses various advantageous properties, especially as compared to “long pass” colored glasses and/or laminated dye plates. For example, the optical filter 100 may be tailored to reflect light a desired wavelength range, while permitting light at other wavelength ranges to be transmitted therethrough. For example, in one embodiment the optical filter 100 may be configured to reflect ultraviolet light, light having a wavelength less than 300 nm, while transmitting light having a wavelength greater than 300 nm. In an alternate embodiment, the optical filter 100 may be configured to reflect light having a wavelength less than 400 nm, while transmitting light having a wavelength greater than 400 nm. In another embodiment, the optical filter 100 may be configured to reflect light having a wavelength less than 500 nm, while transmitting light having a wavelength greater than 500 nm. In another embodiment, the optical filter 100 may be configured to reflect light having a wavelength greater than 680 nm but less than 120 nmAs such, the optical filter 100 filter incident light using a reflecting process or an absorbing/reflecting process, unlike presently available devices which incorporate colored glass and/or laminated dye plate designs configured to absorb UV wavelengths. This is illustrated in Table 1 below:

TABLE 1

| | Optical Filters of | | |
|---|---|---|---|
| | the Present | | Laminated Dye |
| | Application | Colored Glasses | Plates |
| Hazardous | Never present | Can be included | Can be included |
| Materials? | | | |
| Thickness | As desired (can even | Must be thick (3 mm | Must be thick (3 mm |
| | be less than 0.2 mm) | or above) | or above) |
| Size Restrictions? | None (can be >15 | 6.5 in² upper limit | None |
| | inches in diameter) | | |
| Damage when | No damage observed | Damage can occur, | Damage observed at |
| exposed to certain | at 450° C. and above | especially if moisture | temperatures as low |
| temperatures? | | is present as well | as 100° C. |
| Spectral Sensitivity | Low (less than | High (0.06 nm/° C. or | N/A (due to damage |
| due to | 0.0015 nm/° C.) | above) | occurring at such low |
| Temperature | | | temperatures) |
| Autofluorescence? | No | Can occur | Can occur |
| Degradation Upon | No to all | Yes to all | Yes to all |
| Exposure to | | | |
| Environments with | | | |
| in which moisture, | | | |
| acids and/or | | | |
| alkalines? | | | |

### EXAMPLES

Four exemplary optical filters were formed by depositing a coating of alternating layers of two different metal oxides onto a borosilicate glass substrate. In each instance, the oxide layers of the coating were deposited onto the substrate via plasma-enhanced sputtering that occurred within a vacuum. Tables 2-5 below depict the specific formations of the coatings for each of the four respective optical filters, wherein, the “first layer” of the coating is the layer that was deposited directly onto the substrate, and the “last layer” was the top layer of the coating that is exposed to air. In other words, the first layer was deposited directly onto the substrate, and layer 2 was deposited onto the first layer, and layers were further deposited onto each other until the “last layer” is deposited, onto which no additional layer is applied.

TABLE 2
formulation of the coating of the first exemplary optical filter

| Layer | Material | Thickness (in nm) |
|---|---|---|
| 1 (i.e., the first layer) | Tantalum pentoxide | 8.91 |
| 2 | Silicon dioxide | 54.49 |
| 3 | Tantalum pentoxide | 19.9 |
| 4 | Silicon dioxide | 43.46 |
| 5 | Tantalum pentoxide | 29.52 |
| 6 | Silicon dioxide | 31.66 |
| 7, 9, 11, 13, 15, 17, 19, 21, | Tantalum pentoxide | 37.29 |
| 23, 25, 27, 29, 31, 33, 35 | | |
| 8, 10, 12, 14, 16, 18, 20, 22, | Silicon dioxide | 30.74 |
| 24, 26, 28, 30, 32, 34, 36 | | |
| 37 | Tantalum pentoxide | 36.73 |
| 38 | Silicon dioxide | 28.44 |
| 39 | Tantalum pentoxide | 34.64 |
| 40 | Silicon dioxide | 38.59 |
| 41 | Tantalum pentoxide | 18.46 |
| 42 (i.e., the last layer) | Silicon dioxide | 104.33 |

TABLE 3
formulation of the coating of the second exemplary optical filter

| Layer | Material | Thickness (in nm) |
|---|---|---|
| 1 (i.e., the first layer) | Tantalum pentoxide | 9.03 |
| 2 | Silicon dioxide | 69.32 |
| 3 | Tantalum pentoxide | 22.22 |
| 4 | Silicon dioxide | 52.35 |
| 5 | Tantalum pentoxide | 32.48 |
| 6 | Silicon dioxide | 35.01 |
| 7, 9, 11, 13, 15, 17, 19, 21, | Tantalum pentoxide | 38.29 |
| 23, 25, 27, 29, 31, 33 | | |
| 8, 10, 12, 14, 16, 18, 20, 22, | Silicon dioxide | 32.49 |
| 24, 26, 28, 30, 32, 34 | | |
| 35 | Tantalum pentoxide | 38.29 |
| 36 | Silicon dioxide | 46.28 |
| 37 | Tantalum pentoxide | 43.37 |
| 38 | Silicon dioxide | 34.16 |
| 39, 41, 43, 45, 47, 49, 51, 53, | Tantalum pentoxide | 48.92 |
| 55, 57, 59, 61, 63, 65 | | |
| 40, 42, 43, 46, 48, 50, 52, 54, | Silicon dioxide | 41.51 |
| 56, 58, 60, 62, 64, 66 | | |
| 67 | Tantalum pentoxide | 46.99 |
| 68 | Silicon dioxide | 36.23 |
| 69 | Tantalum pentoxide | 48.84 |
| 70 | Silicon dioxide | 45.68 |
| 71 | Tantalum pentoxide | 27.76 |
| 72 (i.e., the last layer) | Silicon dioxide | 127.65 |

TABLE 4
formulation of the coating of the third exemplary optical filter

| Layer | Material | Thickness (in nm) |
|---|---|---|
| 1 (i.e., the first layer) | Titanium oxide | 9.46 |
| 2 | Silicon dioxide | 91.93 |
| 3 | Titanium oxide | 26.29 |
| 4 | Silicon dioxide | 68.08 |
| 5 | Titanium oxide | 41.61 |
| 6 | Silicon dioxide | 49.05 |
| 7, 9, 11, 13, 15, 17, 19, 21, | Titanium oxide | 46.35 |
| 23, 25, 27, 29, 31, 33 | | |
| 8, 10, 12, 14, 16, 18, 20, 22, | Silicon dioxide | 42.46 |
| 24, 26, 28, 30, 32, 34 | | |
| 35 | Titanium oxide | 46.35 |
| 36 | Silicon dioxide | 59.62 |
| 37 | Titanium oxide | 52.77 |
| 38 | Silicon dioxide | 46.03 |
| 39, 41, 43, 45, 47, 49, 51, 53, | Titanium oxide | 59.23 |
| 55, 57, 59, 61, 63, 65, 67 | | |
| 40, 42, 44, 46, 48, 50, 52, 54, | Silicon dioxide | 54.25 |
| 56, 58, 60, 62, 64, 66, 68 | | |
| 69 | Titanium oxide | 56.19 |
| 70 | Silicon dioxide | 50.39 |
| 71 | Titanium oxide | 59.66 |
| 72 | Silicon dioxide | 54.52 |
| 73 | Titanium oxide | 36.43 |
| 74 (i.e., the last layer) | Silicon dioxide | 161.25 |

TABLE 5
formulation of the coating of the fourth exemplary optical filter

| Layer | Material | Thickness (in nm) |
|---|---|---|
| 1 (i.e., the first layer) | Titanium oxide | 24.37 |
| 2 | Silicon dioxide | 73.39 |
| 3, 5, 7, 9, 11, 13, 15, 17, 19, | Titanium oxide | 50.40 |
| 21, 23, 25, 27, 39, 31 | | |
| 4, 6, 8, 10, 12, 14, 16, 18, 20, | Silicon dioxide | 45.15 |
| 22, 24, 26, 28, 30, 32 | | |
| 33 | Titanium oxide | 34.86 |
| 34 | Silicon dioxide | 31.99 |
| 35 | Titanium oxide | 47.37 |
| 36 | Silicon dioxide | 58.62 |
| 37, 39, 41, 43, 45, 47, 49, 51, | Titanium oxide | 64.88 |
| 53, 55, 57, 59, 61, 63, 65 | | |
| 38, 40, 42, 44, 46, 48, 50, 52, | Silicon dioxide | 57.71 |
| 54, 56, 58, 60, 62, 64, 66 | | |
| 67 | Titanium oxide | 64.88 |
| 68 | Silicon dioxide | 85.04 |
| 69 | Titanium dioxide | 72.54 |
| 70 | Silicon oxide | 62.57 |
| 71, 73, 75, 77, 79, 81, 83, 85, | Titanium oxide | 82.89 |
| 87, 89, 91, 93, 95, 97, 99 | | |
| 72, 74, 76, 78, 80, 82, 84, 86, | Silicon dioxide | 73.74 |
| 88, 90, 92, 94, 96, 98, 100 | | |
| 101 | Titanium oxide | 76.08 |
| 102 | Silicon dioxide | 75.32 |
| 103 | Titanium oxide | 80.63 |
| 104 | Silicon dioxide | 66.94 |
| 105 | Titanium oxide | 60.75 |
| 106 (i.e., the last layer) | Silicon dioxide | 202.64 |

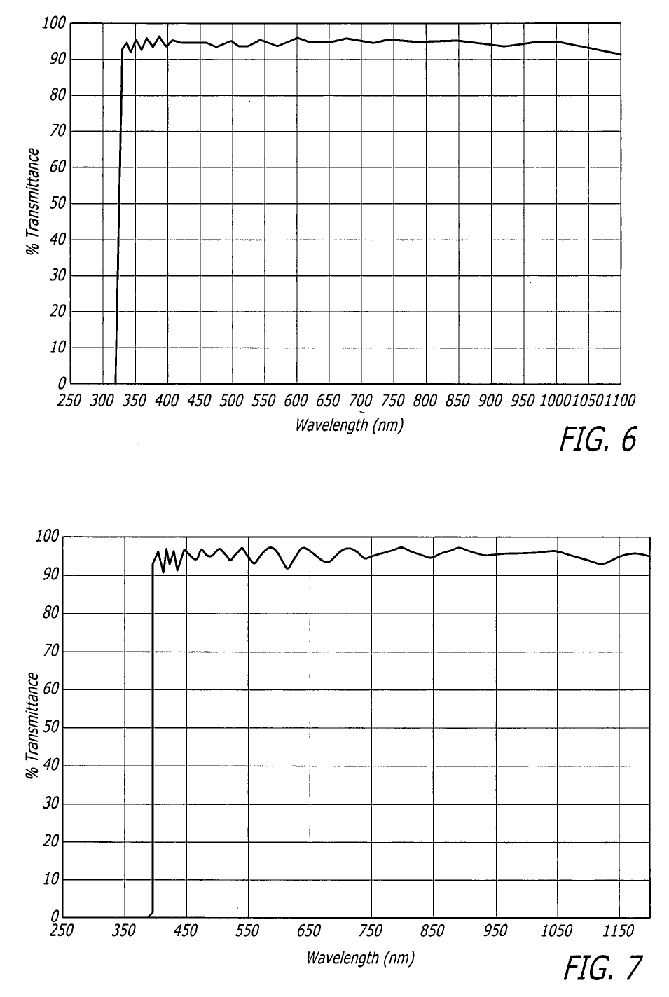

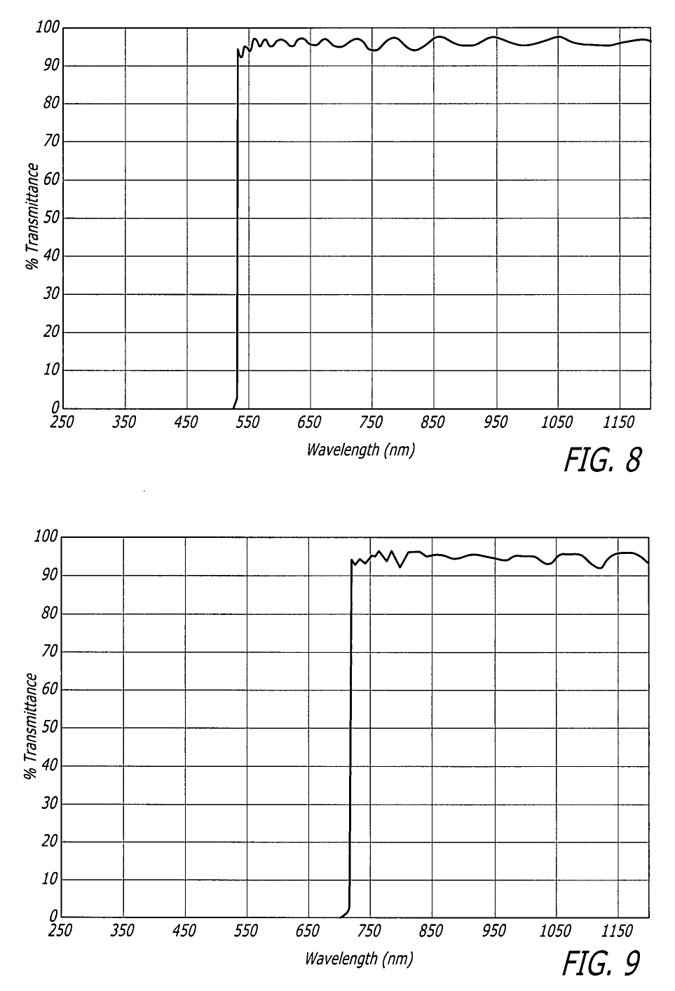

FIGS. 6-9 are graphs depicting the spectral performance of the four exemplary filters described above. In particular, FIG. 6 depicts the spectral performance of the first exemplary optical filter having the formation described in Table 2; FIG. 7 depicts the spectral performance of the second exemplary optical filter having the formation described in Table 3; FIG. 8 depicts the spectral performance of the third exemplary optical filter having the formation described in Table 4; and FIG. 9 depicts the spectral performance of the fourth exemplary optical filter having the formation described in Table 5.

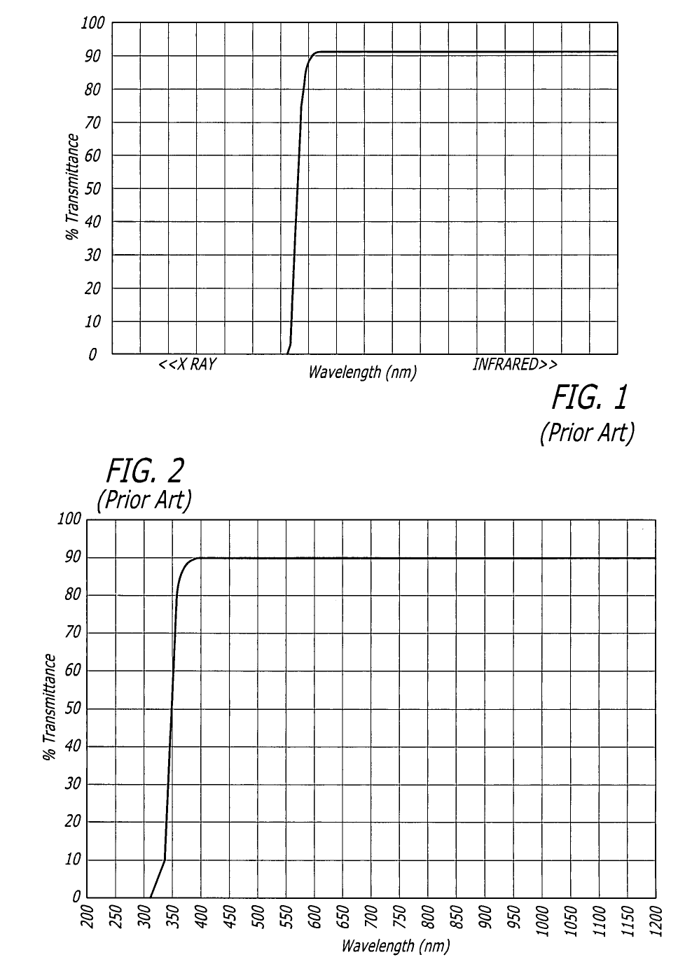

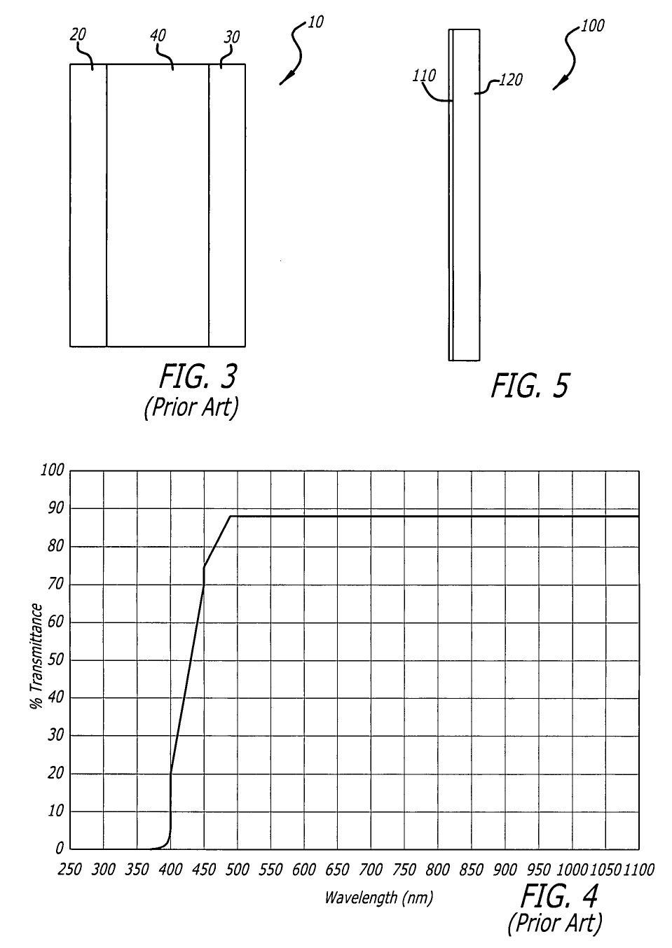

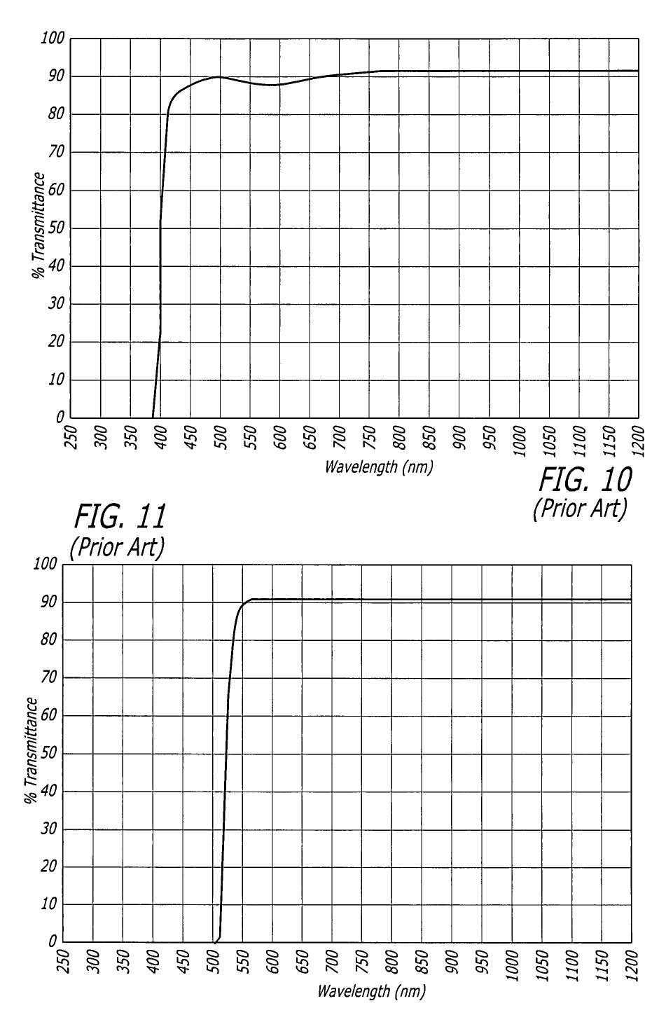

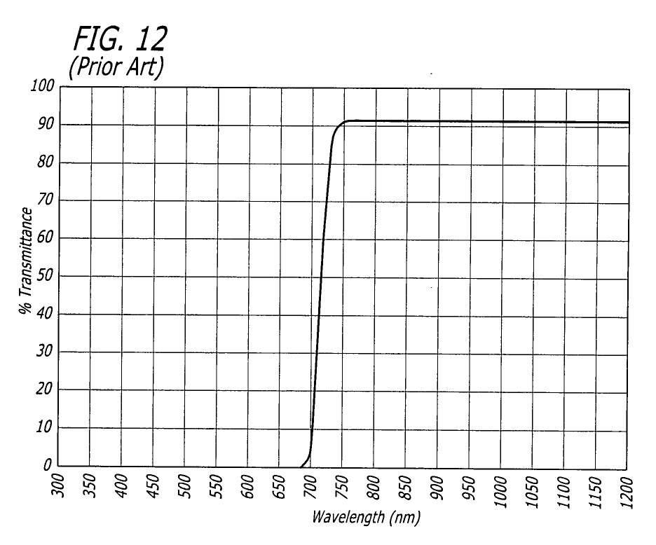

Each of these four exemplary optical filters was manufactured so as to replicate the spectral performance of a different colored glass that is currently or was formerly manufactured by Schott, wherein the spectral performances of these different colored glasses are depicted in FIGS. 2 and 10-12. Specifically, the first exemplary optical filter (the formation details of which are described in Table 2 and the spectral performance of 4which is shown in FIG. 6) was intended to replicate the spectral performance—depicted in FIG. 2—of WG-320 colored glass. The second exemplary optical filter (the formation details of which are described in Table 3 and the spectral performance of which is shown in FIG. 7) was intended to replicate the spectral performance—depicted in FIG. 10—of GG-400 colored glass. The third exemplary optical filter (the formation details of which are described in Table 4 and the spectral performance of which is shown in FIG. 8) was intended to replicate the spectral performance—depicted in FIG. 1—of OG-530 colored glass. The fourth exemplary optical filter (the formation details of which are described in Table 5 and the spectral performance of which is shown in FIG. 9) was intended to replicate the spectral performance—depicted in FIG. 12—of RG-715 colored glass.

Comparing the spectral performance of the four exemplary optical filters to the comparable colored glass (i.e. comparing FIG. 6 to FIG. 2, FIG. 8 to FIG. 11, and FIG. 9 to FIG. 12) and, in the case of GG-400, comparing the optical filter (see FIG. 7) to the colored glass (see FIG. 10) and to the laminated dye plate (see FIG. 4), it is noteworthy that in each instance the optical filter of the present application beneficially replicates the transmittance transition point of its colored glass corollary, but actually has a beneficially steeper edge steepness and a higher level of maximum transmittance. The specific comparisons are set forth in Tables 6-9 below:

TABLE 6

| | First Exemplary | |
|---|---|---|
| | Optical | WG-320 Colored |
| | Filter (see FIG. 6) | Glass (see FIG. 2) |
| Minimum transmittance Percentage | about 0.001% | about 0.001% |
| Minimum Transmittance Level | up to about | up to about |
| | 315 nm | 310 nm |
| Transmittance Transition Point | 320 nm | 320 nm |
| Maximum Transmittance | between about | about 90% |
| Percentage | 92% and 96% | |
| Maximum Transmittance Level | about 325 nm | about 370 nm and |
| | and above | above |
| First Edge Steepness Value (i.e., | about 5 nm | about 10 nm |
| wavelength difference between | | |
| minimum transmittance level and | | |
| transmittance transition point) | | |
| Second Edge Steepness Value (i.e., | about 10 nm | about 60 nm |
| wavelength difference between | | |
| minimum transmittance level and | | |
| maximum transmittance level) | | |

TABLE 7

| | Second Exemplary | GG-400 Colored | Laminated Dye |
|---|---|---|---|
| | Optical Filter | Glass | Plate intended to |
| | (see FIG. 7) | (see FIG. 10) | replicate GG-400 |
| Minimum transmittance | about 0.001% | about 0.001% | about 0.001% |
| Percentage | | | |
| Minimum Transmittance | up to about 385 nm | up to about 385 nm | up to about 375 nm |
| Level | | | |
| Transmittance Transition | 400 nm | 400 nm | about 430 nm |
| Point | | | |
| Maximum Transmittance | between about 90% | between about | about 88% |
| Percentage | and 96% | 87% and 92% | |
| Maximum Transmittance | about 410 nm and | about 500 nm and | about 490 and |
| Level | above | above | above |
| First Edge Steepness Value | about 15 nm | about 15 nm | about 55 nm |
| (i.e., wavelength difference | | | |
| between minimum | | | |
| transmittance level and | | | |
| transmittance transition point) | | | |
| Second Edge Steepness Value | about 25 nm | about 115 nm | about 115 nm |
| (i.e., wavelength difference | | | |
| between minimum | | | |
| transmittance level and | | | |
| maximum transmittance level) | | | |

TABLE 8

| | Third Exemplary | OG-530 |
|---|---|---|
| | Optical Filter | Colored Glass |
| | (see FIG. 8) | (see FIG. 11) |
| Minimum transmittance Percentage | about 0.001% | about 0.001% |
| Minimum Transmittance Level | up to about | up to about |
| | 520 nm | 520 nm |
| Transmittance Transition Point | 530 nm | 530 nm |
| Maximum Transmittance Percentage | between about | about 92% |
| | 92% and 96% | |
| Maximum Transmittance Level | about 535 nm | about 570 nm |
| | and above | and above |
| First Edge Steepness Value (i.e., | about 5 nm | about 10 nm |
| wavelength difference between | | |
| minimum transmittance level and | | |
| transmittance transition point) | | |
| Second Edge Steepness Value (i.e., | about 15 nm | about 50 nm |
| wavelength difference between | | |
| minimum transmittance level and | | |
| maximum transmittance level) | | |

TABLE 9

| | Fourth Exemplary | RG-715 |
|---|---|---|
| | Optical Filter | Colored Glass |
| | (see FIG. 9) | (see FIG. 12) |
| Minimum transmittance Percentage | about 0.001% | about 0.001% |
| Minimum Transmittance Level | Up to about | up to about |
| | 700 nm | 685 nm |
| Transmittance Transition Point | 715 nm | 715 nm |
| Maximum Transmittance Percentage | between about | about 92% |
| | 94% and 97% | |
| Maximum Transmittance Level | about 725 nm | about 765 nm |
| | and above | and above |
| First Edge Steepness Value (i.e., | about 15 nm | about 30 nm |
| wavelength difference between | | |
| minimum transmittance level and | | |
| transmittance transition point) | | |
| Second Edge Steepness Value (i.e., | about 25 nm | about 80 nm |
| wavelength difference between | | |
| minimum transmittance level and | | |
| maximum transmittance level) | | |

Scrutiny of this side-by-side data clearly reveals that optical filters of the present application, as typified by the four exemplary optical filters, perform as well or better than comparable colored glasses in the various noteworthy spectral performance categories. The minimum transmittance values and the transmittance transition point for each optical filter are approximately equal to those of the comparable colored glass. Also, for each optical filter of the present application, the maximum transmittance percentage is equal to or greater than that of the comparable colored glass. This is beneficial because it allows more light to be beneficially transmitted by the optical filter. Moreover, this is also in contrast to the spectral behavior of laminated dye plates, which, as illustrated in the FIG. 4 graph, tends to have a comparably lower maximum transmittance percentage.

Additionally, the optical filters of the present application have a steeper first edge steepness value, which corresponds to the wavelength difference between the minimum transmittance level of the optical filter and the transmittance transition point of the optical filter, and a significantly steeper second edge steepness value, which corresponds to the wavelength difference between the minimum transmittance level of the optical filter and maximum transmittance level of the optical filter. This is particularly advantageous because it signifies that the transitions between the minimum transmittance level of the optical filter and the transmittance transition point of the optical filter and between the minimum transmittance level of the optical filter and maximum transmittance level of the optical filter are more abrupt than those of the comparable colored glasses. Consequently, there are much smaller wavelength spans between these levels for the optical filters than for the comparable colored glasses. That, in turn, will enable the optical filters not only to be used in furtherance of all applications in which comparable colored glasses are used, but perhaps still other applications that would demand such a shorter wavelength span between these levels.

Although the optical filters of the present application have been described herein with reference to details of currently preferred embodiments, it is not intended that such details be regarded as limiting the scope of the invention, except as and to the extent that they are included in the following claims—that is, the foregoing description of the embodiments of the optical filters of the present application are merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

What is claimed is:

1. An optical filter configured to replicate the spectral performance of a colored glass optical device, comprising:
a substrate; and
a coating deposited onto the substrate and configured to reflect light having a wavelength from about, wherein the coating is formed from one or more layers of thin film material,
wherein the optical filter has a minimum spectral transmittance level and a maximum spectral transmittance level, and wherein the transition from the minimum spectral transmittance level to the maximum spectral transmittance level occurs within a wavelength span of less than 100 nm.

2. The device of claim 1 wherein the substrate comprises a non-colored optical substrate.

3. The device of claim 1 wherein the substrate is manufactured from a material selected from the group consisting of silica-based materials, glasses, ceramics, composite materials, deformable optical materials, Mylar, Kapton, polymers, polyimide films, and polyester films.

4. The device of claim 1 wherein the coating has a thickness of about 5 nm to about 1000 nm.

5. The device of claim 1 wherein the coating comprises at least one layer of material selected from the group consisting of oxide materials, metal oxides, silicon oxides, niobium oxides, titanium oxides, hafnium oxides, tantalum oxides, sulfide materials, and fluoride materials.

6. The device of claim 1 wherein the coating comprises alternating layers of high refractive index material and low refractive index materials.

7. The device of claim 1 wherein the coating is configured to reflect light having a wavelength of less than about 300 nm and transmit light having a wavelength of greater than about 300 nm.

8. The device of claim 1 wherein the coating is configured to reflect light having a wavelength of less than about 400 nm and transmit light having a wavelength of greater than about 400 nm.

9. The device of claim 1 wherein the coating is configured to reflect light having a wavelength of less than about 500 nm and transmit light having a wavelength of greater than about 500 nm.

10. The device of claim 1 wherein the coating is configured to reflect light having a wavelength from about 680 nm to about 1200 nm.

11. The device of claim 1 wherein the optical filter has a minimum spectral transmittance level, a maximum spectral transmittance level, and a transmittance transition point therebetween, and wherein the transition from the minimum spectral transmittance level to the maximum spectral transmittance level occurs within a wavelength span of less than 100 nm, and wherein the transition from each of the minimum spectral transmittance level to the transmittance transition point and from the transmittance transition point to the maximum spectral transmittance level occurs within a wavelength span of at most 50 nm.

12. The device of claim 1 wherein the optical filter has a minimum spectral transmittance level and a maximum spectral transmittance level, and wherein the transition between the minimum spectral transmittance level and the maximum spectral transmittance level commences at a maximum wavelength measurement of the minimum spectral transmittance level and concludes at a minimum wavelength measurement of the maximum spectral transmittance level, and wherein the maximum wavelength measurement is equal to at least 80% of the minimum wavelength measurement.

13. The device of claim 1 wherein the optical filter has a minimum spectral transmittance level and a maximum spectral transmittance level, and wherein the transition between the minimum spectral transmittance level and the maximum spectral transmittance level commences at a maximum wavelength measurement of the minimum spectral transmittance level and concludes at a minimum wavelength measurement of the maximum spectral transmittance level, and wherein the maximum wavelength measurement is equal to at least 80% of the minimum wavelength measurement.

14. The device of claim 1 wherein the optical filter has a maximum spectral transmittance level and a transmittance transition point, and wherein the transmittance transition point occurs at a predetermined wavelength, and wherein the transition from the transmittance transition point to the maximum spectral transmittance level commences at the transmittance transition point and concludes at a minimum wavelength measurement of the maximum spectral transmittance level, and wherein the predetermined wavelength of the transmittance transition point is equal to at least 80% of the minimum wavelength measurement of the maximum spectral transmittance level.

15. The device of claim 1 wherein the optical filter has a minimum spectral transmittance level and a maximum spectral transmittance level, and wherein the transition between the minimum spectral transmittance level and the maximum spectral transmittance level commences at a maximum wavelength measurement of the minimum spectral transmittance level and concludes at a minimum wavelength measurement of the maximum spectral transmittance level, and wherein the difference between the minimum wavelength measurement and the maximum wavelength measurement is equal to a wavelength that is less than at least one fourth of the maximum wavelength measurement.

16. An optical filter configured to replicate the spectral performance of a colored glass optical device, comprising:
an optically transparent substrate; and
a coating deposited onto the substrate and configured to reflect light having a wavelength from about, wherein the coating is formed from multiple layers of thin film material and configured to reflect light having a wavelength less than about 300 nm and transmit light having a wavelength greater than about 300 nm,
wherein the optical filter has a minimum spectral transmittance level and a maximum spectral transmittance level, and wherein the transition from the minimum spectral transmittance level to the maximum spectral transmittance level occurs within a wavelength span of less than 100 nm.

17. The device of claim 16 wherein the substrate is manufactured from a material selected from the group consisting of silica-based materials, glasses, ceramics, composite materials, deformable optical materials, Mylar, Kapton, polymers, polyimide films, and polyester films.

18. The device of claim 1 wherein the coating comprises at least one layer of material selected from the group consisting of oxide materials, metal oxides, silicon oxides, niobium oxides, titanium oxides, hafnium oxides, tantalum oxides, sulfide materials, and fluoride materials.

19. The device of claim 1 wherein the coating comprises alternating layers of high refractive index material and low index of refraction materials.

20. A method of manufacturing an optical filter configured to replicate the spectral performance of a colored glass optical device, comprising:
providing an optically transparent substrate;
depositing a coating to the substrate using a reactive plasma-based deposition process by depositing alternating layers of high index of refraction materials and low refracting index materials to the substrate.
